(19) United States
(12) Patent Application Publication
(10) Pub. No.: US 2008/0079861 A1
(43) Pub. Date: Apr. 3, 2008

(54) LIQUID CRYSTAL DISPLAY DEVICE

(76) Inventors: Jeong-min Seo, Cheonan-si (KR); Seok-won Lee, Yongin-si (KR)

Correspondence Address: F. CHAU & ASSOCIATES, LLC, 130 WOODBURY ROAD, WOODBURY, NY, 11797, US

(21) Appl. No.: 11/763,688

(22) Filed: Jun. 15, 2007

(30) Foreign Application Priority Data
Jun. 16, 2006 (KR) 10-2006-0054460

(51) Int. Cl. G02F 1/1333

(52) U.S. Cl. 349/58

(57) ABSTRACT

A liquid crystal display device includes a liquid crystal display panel, a backlight unit that is located at a rear of the liquid crystal display panel, a housing member that accommodates the backlight unit and includes a through hole, a flexible member that covers the through hole and includes an incision part, and a combining member that is combined with the through hole.

A liquid crystal display (LCD) device, in accordance with embodiments of the present invention, reduces contamination due to alien substances.

### CROSS-REFERENCE TO RELATED APPLICATION

This application claims priority to Korean Patent Application No. 2006-0054460, filed on Jun. 16, 2006, the disclosure of which is incorporated herein by reference in its entirety.

### BACKGROUND OF THE INVENTION

1. Technical Field

The present invention relates to a liquid crystal display (LCD) device.

2. Discussion of the Related Art

Flat display devices, such as a liquid crystal display (LCD), a plasma display panel (PDP) or an organic light emitting diode (OLED) display device, have been developed as an alternative to a cathode ray tube (CRT).

An LCD device may comprise an LCD panel and a backlight unit placed behind the LCD panel. As the LCD panel does not emit light by itself, the LCD panel can display an image using light received from the backlight unit.

The LCD panel and the backlight unit are accommodated in a housing member. For example, the housing member comprises an upper housing member and a lower housing member, and may further comprise a mold frame.

An LCD device can be connected and fixed to a bracket in the process of assembling complete display sets. Screws have been used to connect the LCD device to the bracket. To this end, combining holes are provided in the bracket and the LCD device, respectively.

However, the LCD device may be contaminated by alien substances introduced into the LCD device through the combining holes before the complete display sets are assembled.

Accordingly, there is a need for a liquid crystal display (LCD) device that reduces contamination due to alien substances.

### SUMMARY OF THE INVENTION

A liquid crystal display device, in accordance with an embodiment of the present invention, comprises a liquid crystal display panel, a backlight unit that is located at rear of the liquid crystal display panel, a housing member that accommodates the backlight unit and includes a through hole, a flexible member that covers the through hole and includes an incision part, and a combining member combined with the through hole for combination to an external part.

The flexible member may be attached to an inner surface of the housing member.

The combining member may be press fitted to the through hole and at least a part of the combining member may project externally from the housing member.

The incision part may correspond to the through hole.

The combining member may include a combining hole having a female screw thread.

The incision part may have a cross shape.

The incision part may be formed to be symmetrical around the center of the combining hole.

The incision part may comprise at least one straight line part passing through the center of the combining hole.

The length of the straight line part may be about 80% to about 120% of the diameter of the combining hole.

The combining member may comprise a stud nut.

The housing member and the combining member may comprise metal.

The flexible member may comprise polyethylene terephthalate (PET).

The housing member may comprise a first side parallel to the liquid crystal display panel and a second side that is extends from the first side at an angle with respect to the first side. The through hole may be formed in the second side.

The backlight unit may include an escape space at a portion corresponding to the through hole.

The backlight unit may comprise a light guiding plate, and the escape space may foe provided in the light guiding plate.

The through hole may correspond to an edge of the light guiding plate.

A liquid crystal display device, in accordance with an embodiment of the present invention, comprises a liquid crystal display panel, a backlight unit that is located at a rear of the liquid crystal display panel, a housing member that surrounds the perimeter of the backlight unit and includes a through hole, and a flexible member that is attached to the housing member, and includes an incision part at a portion corresponding to the through hole.

The liquid crystal display device may further comprise a combining member combined with the through hole.

The flexible member may be attached to an inner surface of the housing member.

### BRIEF DESCRIPTION OF THE DRAWINGS

Exemplary embodiments of the present invention can be understood in more detail from the following description, taken in conjunction with the accompanying drawings of which:

FIG. 1 is a perspective view of an LCD device according to an embodiment of the present invention;

FIG. 2 is an exploded perspective view of the LCD device shown in FIG. 1, according to an embodiment of the present invention;

FIG. 3 is a view illustrating a connection between a combining member and a lower housing member of an LCD device according to an embodiment of the present invention;

FIG. 4 is a plan view of part of an LCD device according to an embodiment of the present invention;

FIG. 5 is a view illustrating a flexible member in an LCD device according to an embodiment of the present invention;

FIG. 6 is a perspective view illustrating assembling of a display set including an LCD device according to an embodiment of the present invention;

FIG. 7 is a perspective view of part of a display set according to an embodiment of the present invention;

FIG. 8 is a view illustrating a flexible member in an LCD device according to an embodiment of the present invention;

FIG. 9 is a view illustrating an LCD device according to an embodiment of the present invention; and

FIGS. 10A and 10B are perspective views illustrating assembling display sets according to an embodiment of the present invention.

### DETAILED DESCRIPTION OF EMBODIMENTS

Exemplary embodiments of the present invention will now be described more fully hereinafter below in more detail with reference to the accompanying drawings. This invention may, however, be embodied in different forms and should not be construed as limited to the embodiments set forth herein.

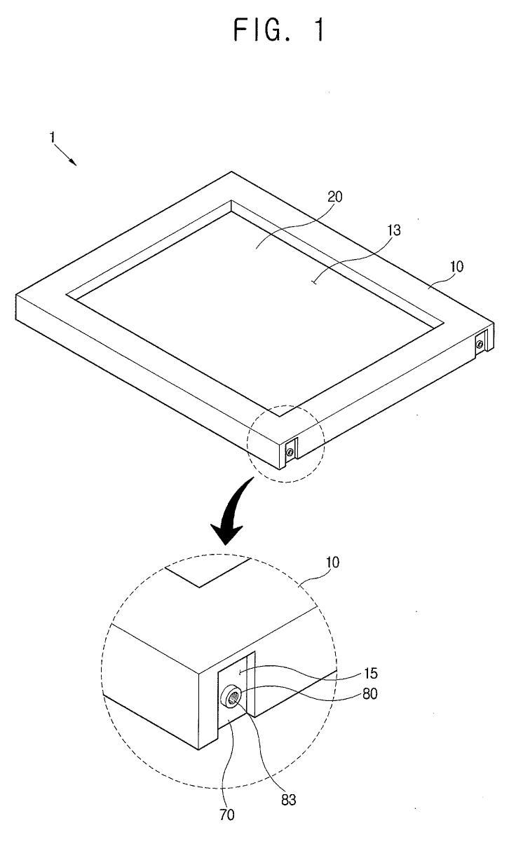

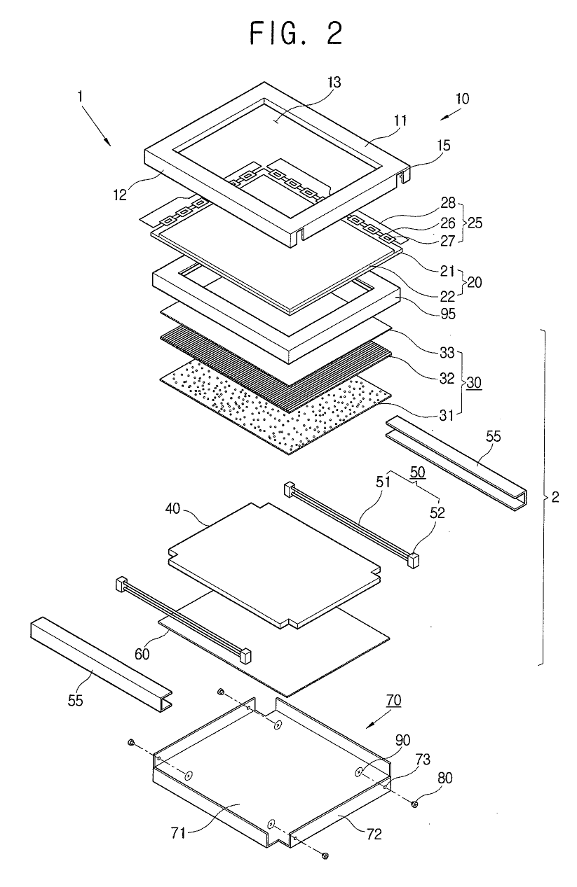

Referring to FIGS. 1 and 2, an LCD device 1 comprises an LCD panel 20 positioned between an upper housing member 10 and a lower housing member 70.

The upper housing member 10 is formed with an opening 13 to expose the LCD panel 20. A portion of one of sides of the upper housing member 10 is removed to form an exposing part 15 to expose part of the lower housing member 70.

A combining member 80 is coupled to the part of the lower housing member 70 exposed by the exposing part 15. A combining hole 83 with a female screw thread is formed in the combining member 80. The LCD device 1 is coupled to an external structure through the combining hole 83.

Referring to FIG. 2, the LCD device 1 comprises an LCD panel 20 and a backlight unit 2 located behind the LCD panel 20. The backlight unit 2 comprises a plurality of optical films 30, and a light guiding plate 40, which are provided behind the LCD panel 20. A pair of light sources 50 is provided at opposite lateral sides of the light guiding plate 40, and a reflection plate 60 is provided below the light guiding plate 40. The LCD panel 20 and the backlight unit 2 are positioned between the upper housing member 10 and the lower housing member 70. The LCD panel 20 is stably seated on a plastic mold 95.

The LCD panel 20 comprises a thin film transistor substrate 21 on which thin film transistors are formed, and a color filter substrate 22 which faces the thin film transistor substrate 21. A liquid crystal layer (not shown) is provided between the thin film transistor substrate 21 and the color filter substrate 22. The LCD panel 20 displays an image by adjusting an alignment of liquid crystals in the liquid crystal layer. Since the LCD panel 20 does not emit light by itself, the LCD panel receives light from the light sources 50. A driver 25 is provided at a lateral side of the thin film transistor substrate 21 to supply driving signals. The driver 25 comprises a flexible printed circuit board (FPC) 26, a driving chip 27, which is mounted on the FPC 26, and a printed circuit board (PCB) 28, which is connected with a the FPC 26. The driver 25 can be a chip on film (COF) type, but is not limited thereto. Alternatively, the driver 25 may be, for example, a tape carrier package (TCP) or a chip on glass (COG) type. The driver 25 may be mounted on the thin film transistor substrate 21. In alternative embodiments, the driver 25 of the LCD device 1 may foe exposed to the outside for connection with an external circuit.

The optical films 30 provided behind the LCD panel 20 comprise a diffusion film 31, a prism film 32 and a protective film 33.

The diffusion film 31 comprises a base plate and a bead-like coating layer which is formed on the base plate. The diffusion film 31 diffuses light from the light sources 50 to be supplied to the LCD panel 20. The diffusion film 31 may be provided in two or three folds.

On the prism film 32 are formed triangular prisms at regular intervals. The prism film 32 collects light diffused by the diffusion film 31 in a direction perpendicular to the LCD panel 20. The prism film 32 may be provided in two sheets. Micro prisms, which are formed on each of the prism films 32, form a predetermined angle. Most of light passing through the prism film 32 travels in a vertical direction to provide uniform brightness.

The protection film 33 on the prism film protects the prism film 32 from being scratched.

The light guiding plate 40 comprises, for example, acrylic resin such as polymethylmethacrylate (PMMA). The light guiding plate 40 uniformly provides light from the light sources 50 to the diffusion film 31. According to an embodiment, the light guiding plate 40 has a rectangular shape whose four corners are removed.

The light sources 50 are provided as a pair and face each other, with the light guiding plate 40 positioned between the light sources 50. According to an embodiment, each of the light sources 50 comprises a lamp main body 51 and lamp holders 52 which are provided at opposite ends of the lamp main body 51. The light sources 50 may comprise a cold cathode fluorescent lamp (CCFL) or an exterior electrode fluorescent lamp (EEFL). Alternatively, the light sources 50 may comprise light emitting diodes (LEDs).

Light source covers 55 cover the light sources 50 and reflect light from the light sources 50 toward the light guiding plate 40. Each light source cover 55 has a two-layered structure in which an inner side of the light source cover 55 faces the light source 50 and comprises, for example, a polyethylene terephthalate (PET) layer. An outer side of each light source cover 55 comprises an aluminum layer having good thermal conductivity.

The reflection plate 60 is located below the light guiding plate 40 and reflects light back to the light guiding plate 40. The reflection plate 70 is made of plastic such as, for example, polyethylene terephthalate (PET) or polycarbonate (PC).

As described above, the LCD panel 20 and the backlight unit 2 are accommodated between the upper housing member 10 and the lower housing member 70. A flexible member 90 is combined with the combining member 80 in the lower housing member 70.

The upper housing member 10 comprises a first side 11 parallel to the LCD panel 20 and a second side 12 which extends from the first side 11 at an angle, for example, at substantially 90 degrees with respect to the first side 11. In the first side 11 is formed an opening 13 to expose the LCD panel 20. A portion of the second side 12 is removed to form an exposing part 15 to expose the combining member 80.

The lower housing member 70 comprises a first side 71 parallel to the LCD panel 20 and four second sides 72 which extend from the first side 71 at an angle, for example, at substantially 90 degrees with respect to the first side 71. The lower housing member 70 may comprise metal. The four second sides 72 enclose four sides of the LCD panel 20. Two of the four second sides 72 extend in a direction perpendicular to a lengthwise direction of the light sources 50 and each have two through holes 73, respectively. The through holes 73 are formed at both ends of the second sides 72.

The combining member 80 connects the LCD device 1 to an external structure and is combined with the lower housing member 70 through the through holes 73.

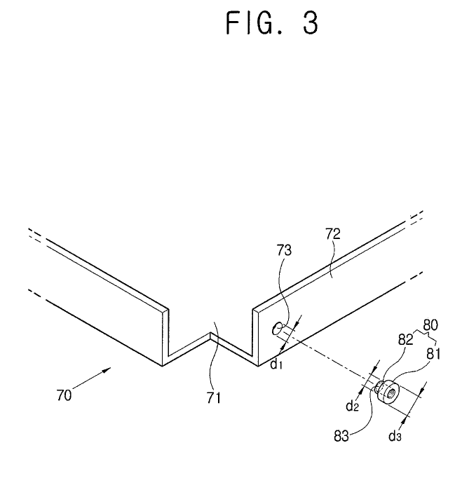

Referring to FIG. 3, the combining member 80, is, for example, a stud nut made of metal, comprising a head 81 and an insertion part 82 having a relatively small diameter with respect to a diameter of the head 81. The combining member 80 includes a combining hole 83 passing through the head 81 and the insertion part 82. The combining hole 83 includes a female screw thread.

The combining member 80 is fixed to the lower housing member 70 when the insertion part 82 is press fitted to a through hole 73. For the press fitting, the diameter d2 of the insertion part 82 is approximately equal to or slightly larger than the diameter d1 of the through hole 73. With the combining member 80 combined to the lower housing member 70, the head 81 having the relatively large diameter d3 projects toward the outside of the lower housing member 70.

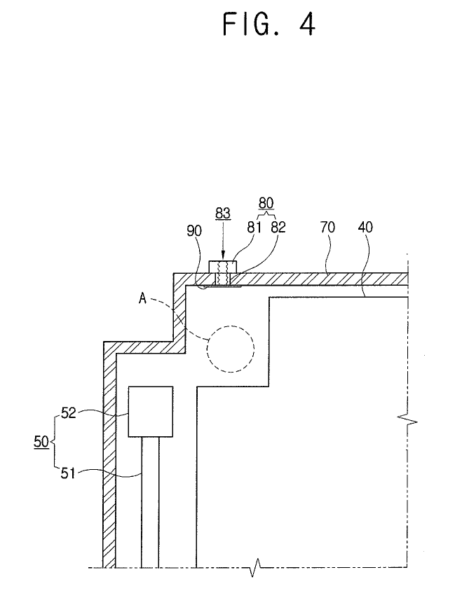

Referring to FIG. 4, with the combining member 80 combined with the lower housing member 70, an end of the insertion part 82 may be substantially flush with the inside surface of the lower housing member 70. Alternatively, the end of the insertion part 82 may slightly project toward the inside of the lower housing member 70. The combining hole 83 faces a cut edge of the light guiding plate 40, thereby defining an escape space A between the combining hole 83 and the light guiding plate 40.

In this manner, the lower housing member 70 and the combining member 80, which are made of metal, can be combined. Accordingly, there is no need to separate the lower housing member 70 from the combining member 80 for reuse.

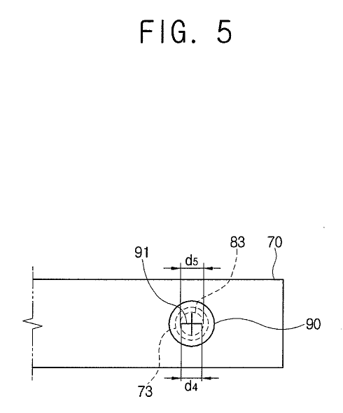

Referring to FIGS. 4 and 5, the flexible member 90 is attached to the inside of the lower housing member 70 to cover the through hole 73. The flexible member 90 prevents alien substances from being introduced into the LCD device 1 through the through hole 73. That is, the flexible member 90 separates the backlight unit 2 from the outside. The flexible member 90 may comprise, for example, tape.

In accordance with an embodiment, the flexible member 90 has a circular shape and a cross-shaped incision part 91 is formed in the center of the flexible member 90. The center of the incision part 91 coincides with the center of the through hole 73, and the combining hole 83. The length d4 of the incision part 91 may be equal to about 80% to about 120% of the diameter d5 of the combining hole 83. The flexible member 90 is made of, for example, polymer, such as, polyethylene terephthalate (PET) having good elasticity.

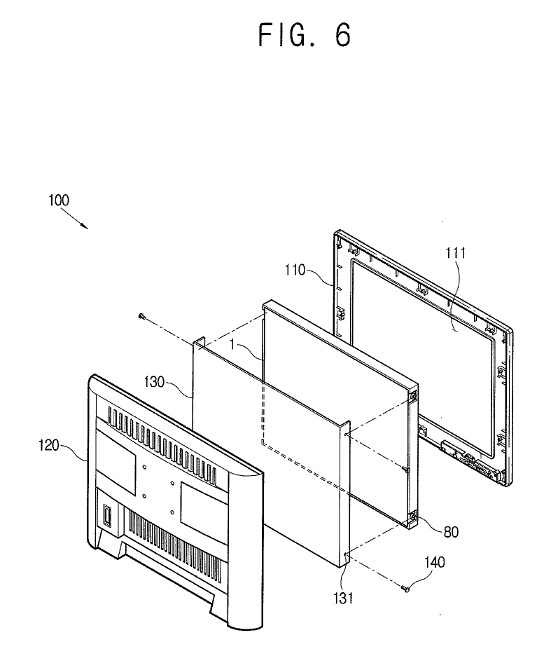

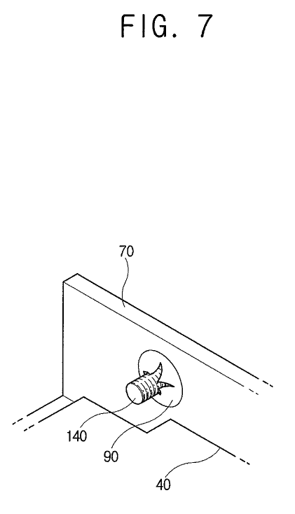

The combining member 80 and the flexible member 90 are described in more detail with reference to FIGS. 6 and 7. In alternative embodiments, the driver 25 of the LCD device 1 may be exposed to the outside for connection with an external circuit.

Referring to FIG. 6, an LCD device 1 according to an embodiment of the present invention is covered by a front cover 110 and a rear cover 120 to form a display set 100. An opening 111 to expose the LCD device 1 is formed in the front cover 110. The LCD device 1 is fixed by a metal bracket 130 of the complete display set 100. The bracket 130 has a bracket combining hole 131 corresponding to the combining member 80.

The LCD device 1 and the bracket 130 are coupled to each other using, for example, a screw 140. The screw 140 passes through the bracket combining hole 131 and the combining hole 83 of the LCD device 1 to combine the LCD device 1 with the bracket 130.

In an embodiment, when the screw 140 is long, an end of the screw 140 passes through the combining member 80 and extends into the escape space A as shown in FIG. 7. As a result, the flexible member 90 is deformed by the screw 140. The screw 140 deforms only the circumference of the cross-shaped incision part 91 formed in the flexible member 90. The incision part 91 prevents a remaining portion of the flexible member 90 from being deformed and prevents the flexible member 90 from being separated from the lower housing member 70.

The flexible member 90 encloses the screw 140 extending into the LCD device 1 by elasticity. When the flexible member 90 is made of, for example, polyethylene terephthalate (PET) having good elasticity, it may enclose the screw 140 tightly so as to prevent alien substances from being introduced into the LCD device.

The length d4 of the incision part 91 shown in FIG. 5 may be equal to about 80% to about 120% of the diameter d5 of the combining hole 83. If the length d4 of the incision part 91 is less than about 80% of the diameter d5 of the combining hole 83, the amount of deformation of the circumference of the incision part 91 may increase, which may result in separation of the flexible member 90 from the lower housing member 70. If the length d4 of the incision part 91 is more than about 120% of the diameter d5 of the combining hole 83, the flexible member 90 deformed after combination by the screw 140 may not enclose the circumference of the screw tightly.

The screw 140 extending into the LCD device 1 is located within the escape space A without damaging the backlight unit 2.

The flexible member 90 prevents alien substances from being introduced into the LCD device 1 through the through hole 73 while the display set 100 is assembled. In addition, the flexible member 90 prevents alien substances from being introduced into the LCD device 1 by enclosing the screw 140 after assembly of the display set 100. Moreover, since the flexible member 90 is stably fixed to the lower housing member 70, it can be prevented from being separated from the lower housing member 70.

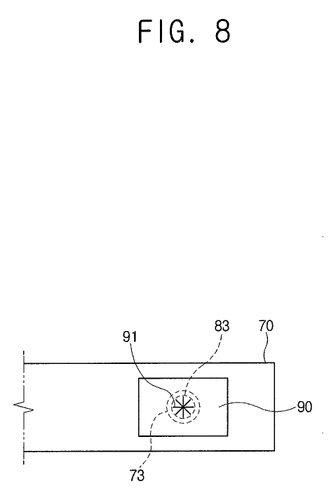

Referring to FIG. 8, a flexible member in an LCD device according to an embodiment of the present invention, covers the through hole 73, and has a rectangular shape. The incision part 91 is formed with four straight lines symmetrically arranged around the through hole 73.

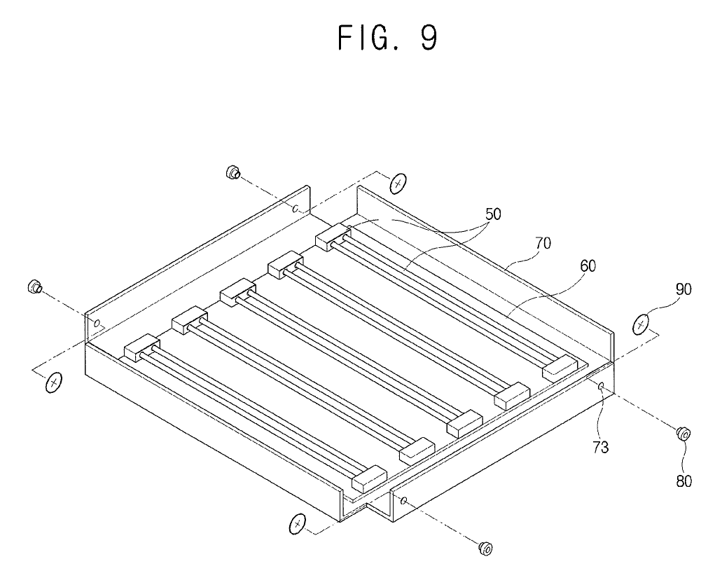

Referring to FIG. 9 showing an LCD device according to an embodiment of the present invention, the backlight unit 2 of the LCD device is a direct-below type. The light sources 50 are formed in a line to the rear of the LCD panel 20 and the light guiding plate 40 is not used. The direct-below type backlight unit 2 can improve brightness, may be used for a large LCD device 1.

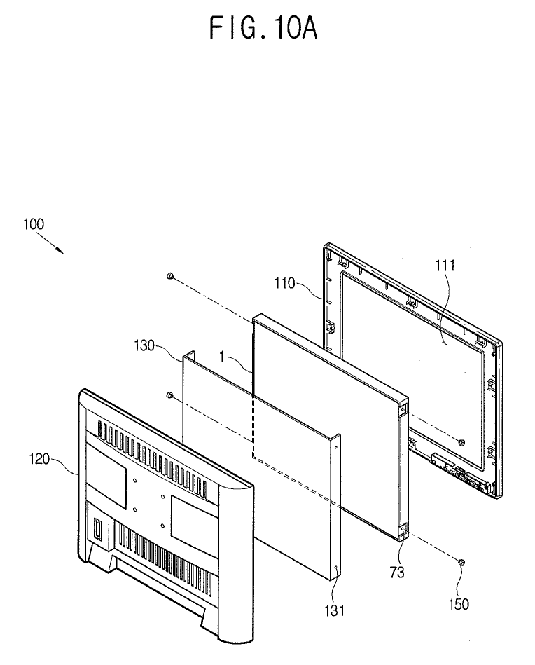

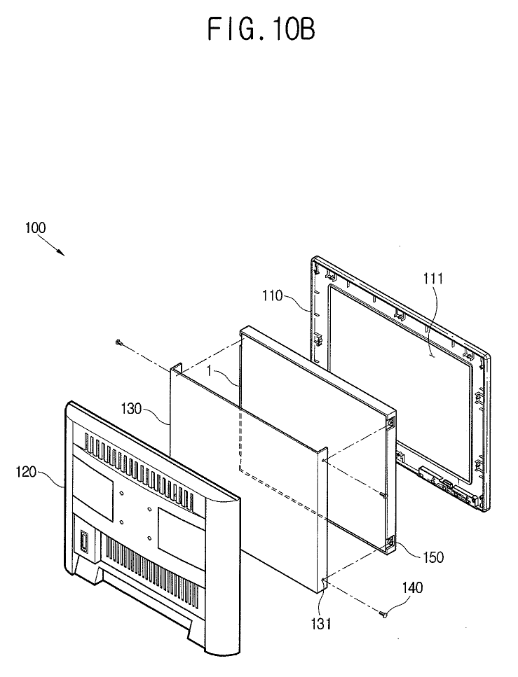

FIGS. 10A and 10B illustrate assembling a display set including an LCD device according to an embodiment of the present invention.

Referring to FIG. 10A, the LCD device 1 does not include a combining member. Accordingly, the through hole 73 of the lower housing member 70 is exposed at the time of assembly into the display set 100. Although not shown, the flexible member 90 covering the through hole 73 and having an incision part is formed on an inner side of the lower housing member 70.

A combining member 150 is coupled to the through hole 73 before a screwing operation in a process of assembling the display set 100.

Thereafter, the combining member 150 combined with the LCD device 1 is combined with the bracket 130 by using the screw 140, as shown in FIG. 10B. Accordingly, the LCD device 1 is combined with the bracket 130.

The above-described embodiments may be modified. For example, the combining member 80 may be fixed by methods other than force fitting into the lower housing member 70, or may be integrated with the lower housing member 70. The combining member 80 is not limited to a stud nut. The combining member 80 may be combined to the upper housing member 10 or the mold frame 55.

The embodiments of the present invention provide a liquid crystal display device, wherein contamination due to alien substances is reduced.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display device comprising:
a liquid crystal display panel;
a backlight unit located at a rear of the liquid crystal display panel;
a housing member accommodating the backlight unit and including a through hole;
a flexible member covering the through hole and including an incision part; and
a combining member combined with the through hole.

2. The liquid crystal display device according to claim 1, wherein the flexible member is attached to an inner surface of the housing member.

3. The liquid crystal display device according to claim 2, wherein the combining member is press fitted in the through hole and at least a part of the combining member projects externally from the housing member.

4. The liquid crystal display device according to claim 2, wherein the incision part corresponds to the through hole.

5. The liquid crystal display device according to claim 4, wherein the combining member includes a combining hole having a female screw thread.

6. The liquid crystal display device according to claim 4, wherein the incision part has a cross shape.

7. The liquid crystal display device according to claim 6, wherein the incision part is symmetrical around the center of the combining hole.

8. The liquid crystal display device according to claim 6, wherein the incision part comprises at least one straight line part passing through the center of the combining hole.

9. The liquid crystal display device according to claim 8, wherein a length of the straight line part is about 80% to about 120% of the diameter of the combining hole.

10. The liquid crystal display device according to claim 3, wherein the combining member comprises a stud nut.

11. The liquid crystal display device according to claim 1, wherein the housing member and the combining member comprise metal.

12. The liquid crystal display device according to claim 1, wherein the flexible member comprises polyethylene terephthalate (PET).

13. The liquid crystal display device according to claim 1, wherein:
the housing member comprises a first side parallel to the liquid crystal display panel and a second side extending from the first side at an angle, and
the through hole is formed in the second side.

14. The liquid crystal display device according to claim 13, wherein the backlight unit includes an escape space at a portion corresponding to the through hole.

15. The liquid crystal display device according to claim 14, wherein the backlight unit comprises a light guiding plate, and the escape space is provided in the light guiding plate.

16. The liquid crystal display device according to claim 15, wherein the through hole is provided to correspond to an edge of the light guiding plate.

17. A liquid crystal display device comprising:
a liquid crystal display panel;
a backlight unit located at a rear of the liquid crystal display panel;
a housing member surrounding a perimeter of the backlight unit and including a through hole; and
a flexible member attached to the housing member, wherein the flexible member is formed with an incision part at a portion corresponding to the through hole.

18. The liquid crystal display device according to claim 17, further comprising a combining member combined with the through hole.

19. The liquid crystal display device according to claim 17, wherein the flexible member is attached to an inner surface of the housing member.

20. An assembling method of a liquid crystal display device and a bracket comprising:
preparing the liquid crystal display device and the bracket,
the liquid crystal display device comprising:
a liquid crystal display panel;
a backlight unit located at a rear of the liquid crystal display panel;
a housing member accommodating the backlight unit and including a through hole and;
a flexible member covering the through hole and including an incision part; and
a combining member combined with the through hole,
the bracket being formed with a bracket combining hole;
passing a screw through the through hole and the bracket combining hole to combine the screw with the combining member.
